(19) United States
(12) Patent Application Publication
(10) Pub. No.: US 2025/0380719 A1
(43) Pub. Date: Dec. 18, 2025

(54) A PROCESS FOR PREPARING A TEXTURIZED PLANT-BASED FOOD PRODUCT

(71) Applicant: SOCIETE DES PRODUITS NESTLE S.A., Vevey (CH)

(72) Inventors: NADJI REKHIF, Solon, OH (US); DAVID KOMAREK, Hilzingen (DE); RICARDO MOURA, Shaker Heights, OH (US); SANYASI GADDIPATI, Hudson, OH (US); TILMAN JOHANNES SCHOBER, Bedford, OH (US); MARIA MONTEIRO DE ARAUJO SILVA, Singen (DE)

(21) Appl. No.: 18/867,495

(22) PCT Filed: May 24, 2023
(86) PCT No.: PCT/EP2023/063954

§ 371 Date: Nov. 20, 2024

Related U.S. Application Data
(60) Provisional application No. 63/345,544, filed on May 25, 2022.

(51) Int. Cl. A23J 3/26; A23J 3/16; A23J 3/22

(52) U.S. Cl. CPC A23J 3/26; A23J 3/16; A23J 3/227

(57) ABSTRACT

The invention generally relates to a process for preparing a texturized plant-based food product. More specifically the invention relates to a process for preparing a texturized plant-based food product with a fibrous appearance and less plant protein off-taste having 0.1-5 wt % sugar and 0.05-1 wt % cysteine or glutathione or a combination thereof.

The invention generally relates to a process for preparing a texturized plant-based food product. More specifically the invention relates to a process for preparing a texturized plant-based food product with a fibrous appearance and less plant protein off-taste having 0.1-5 wt % sugar and 0.05-1 wt % cysteine or glutathione or a combination thereof.

In recent years, it has become common for consumers to choose foods that are convenient and tasty. However, convenient or ready-to-eat foods tend to be nutritionally unbalanced as they are high in fat and low in dietary fiber and protein. In particularly, it is considered that the high fat and low dietary fiber level of these convenient foods can contribute to obesity and various chronic diseases, such as coronary heart disease, stroke, diabetes, and certain types of cancer.

It is well known that by supplementing foods with increased levels of dietary fiber and protein, taste can be seriously compromised as off-flavours result in a chalky and bland taste. In addition to the challenges associated with improving taste, it is known that increasing a food's protein level typically results in the loss of the desirable product flavor that consumers expect. This is especially critical for texturized plant-based food products.

Hence, there is an existing need in the art and industry to provide a better solution for texturized plant-based food products for humans having a fibrous appearance with good taste properties, especially with less plant protein off-note and a more authentic meaty taste.

The object of the present invention is to improve the state of the art or at least provide an alternative for a texturized plant-based food product: i) a texturized plant-based food product for humans; ii) a texturized plant-based food product with a high protein content; iii) a texturized plant-based food product with a protein content above 25 wt %, preferably above 30 wt %; iv) a texturized plant-based food product having a fibrous appearance with good taste properties; v) a texturized plant-based food product having a fibrous appearance having starch or starch flour in a low amount; vi) a texturized plant-based food product having good taste properties; vii) a texturized plant-based food product having a reduced off-taste of the plant-protein; viii) a texturized plant-based food product having a reduced off-taste of the plant-protein and a meat taste; x) a texturized plant-based food product having a reduced off-taste of the plant-protein and a savory and/or meat-like taste;

The object of the present invention is achieved by the subject matter of the independent claims. The dependent claims further develop the idea of the present invention.

Accordingly, the present invention provides in a first aspect a process for preparing a texturized plant-based food product, the process comprising the steps of:
a) feeding a chamber with a composition comprising 10-70 wt % water, 15-80 wt % plant protein, 0.1-5 wt % sugar and 0.05-1 wt % cysteine or glutathione or a combination thereof;
b) conveying the composition from step a) through the chamber and applying shear, wherein the composition reaches a temperature between 80 to 200° C. under a pressure between 3 to 40 bar to texturize the plant protein;
c) cooling the composition from step b);

In an embodiment the present invention provides a process for preparing a texturized plant-based food product, the process comprising the steps of:
a) feeding a chamber with a composition comprising 10-70 wt % water, 15-80 wt % plant protein, 0.1-5 wt % sugar and 0.05-1 wt % cysteine or glutathione or a combination thereof;
b) conveying the composition from step a) through the chamber and applying shear, wherein the composition reaches a temperature between 80 to 200° C. under a pressure between 3 to 40 bar to texturize the plant protein;
c) cooling the composition from step b);
d) cutting the cooled texturized composition from step c).

In an embodiment the present invention provides a process for preparing a texturized plant-based food product, the process comprising the steps of:
a) feeding a chamber with a composition comprising 10-70 wt % water, 15-80 wt % plant protein, 0.1-5 wt % sugar and 0.05-1 wt % cysteine or glutathione or a combination thereof;
b) conveying the composition from step a) through the chamber and applying shear, wherein the composition reaches a temperature between 80 to 200° C. under a pressure between 3 to 40 bar to texturize the plant protein;
c) cooling the composition from step b);
   wherein the process is an extrusion process and wherein the chamber is an extruder barrel.

In an embodiment the present invention provides a process for preparing a texturized plant-based food product, the process comprising the steps of:
a) feeding a chamber with a composition comprising 10-70 wt % water, 15-80 wt % plant protein, 0.1-5 wt % sugar and 0.05-1 wt % cysteine or glutathione or a combination thereof;
b) conveying the composition from step a) through the chamber and applying shear, wherein the composition reaches a temperature between 80 to 200° C. under a pressure between 3 to 40 bar to texturize the plant protein;
c) cooling the composition from step b);
d) cutting the cooled texturized composition from step c).
   wherein the process is an extrusion process and wherein the chamber is an extruder barrel.

In an embodiment the present invention provides a process for preparing a texturized plant-based food product, the process comprising the steps of:
a) feeding a chamber with a composition comprising 45-70 wt % water, 15-35 wt % plant protein, 0.1-5 wt % sugar and 0.05-1 wt % cysteine or glutathione or a combination thereof;
b) conveying the composition from step a) through the chamber and applying shear, wherein the composition reaches a temperature between 80 to 200° C. under a pressure between 3 to 40 bar to texturize the plant protein;
c) cooling the composition from step b);
d) cutting the cooled texturized composition from step c).
   wherein the process is an extrusion process and wherein the chamber is an extruder barrel, and the cooling is done through a cooling die.

In an embodiment the present invention provides a process for preparing an extruded plant-based food product, the process comprising the steps of:
a) feeding an extruder barrel with a composition comprising 10-70 wt % water, 15-80 wt % plant protein, 0.1-5 wt % sugar and 0.05-1 wt % cysteine or glutathione or a combination thereof;
b) extruding the composition from step a) in extruder barrels above the texturization temperature of the plant protein at a temperature between 80 to 200° C.;
c) cooling the composition from step b).

In an embodiment the present invention provides a process for preparing an extruded plant-based food product, the process comprising the steps of:
a) feeding an extruder barrel with a composition comprising 10-70 wt % water, 15-80 wt % plant protein, 0.1-5 wt % sugar and 0.05-1 wt % cysteine or glutathione or a combination thereof;
b) extruding the composition from step a) in extruder barrels above the texturization temperature of the plant protein at a temperature between 80 to 200° C.;
c) cooling the composition from step b);
d) cutting the cooled extruded composition from step c).

In an embodiment the present invention provides a process for preparing an extruded plant-based food product, the process comprising the steps of:
a) feeding an extruder barrel with a composition comprising 45-70 wt % water, 15-35 wt % plant protein, 0.1-5 wt % sugar and 0.05-1 wt % cysteine or glutathione or a combination thereof;
b) extruding the composition from step a) in extruder barrels above the texturization temperature of the plant protein at a temperature between 80 to 200° C.;
c) cooling the composition from step b) through a cooling die;
d) cutting the cooled extruded composition from step c).

In an embodiment the present invention provides a process for preparing an extruded plant-based food product, the process comprising the steps of:
a) feeding an extruder barrel with a composition comprising 10-35 wt % water, 25-80 wt % plant protein, 0.1-5 wt % sugar and 0.05-1 wt % cysteine or glutathione or a combination thereof;
b) extruding the composition from step a) in extruder barrels above the texturization temperature of the plant protein at a temperature between 80 to 200° C.;
c) cooling the composition from step b).

In an embodiment the present invention provides a process for preparing an extruded plant-based food product, the process comprising the steps of:
a) feeding an extruder barrel with a composition comprising 10-35 wt % water, 25-80 wt % plant protein, 0.1-5 wt % sugar and 0.05-1 wt % cysteine or glutathione or a combination thereof;
b) extruding the composition from step a) in extruder barrels above the texturization temperature of the plant protein at a temperature between 80 to 200° C.;
c) cooling the composition from step b);
d) drying the extruded composition from step c).

In an embodiment the present invention provides a process for preparing a texturized plant-based food product, the process comprising the steps of:
a) Heating a composition comprising sugar and cysteine or glutathione or a combination thereof with at least one further amino acid or vitamin selected from arginine, glutamic acid, alanine, glycine, lysine, threonine, thiamine or a combination thereof to a temperature between 40 to 100° C. for 2 to 60 min to obtain a pre-reacted flavor precursor;
b) feeding a chamber with a composition comprising 10-70 wt % water, 15-80 wt % plant protein and the pre-reacted flavor precursor from step a);
c) conveying the composition from step b) through the chamber and applying shear, wherein the composition reaches a temperature between 80 to 200° C. under a pressure between 3 to 40 bar to texturize the plant protein;
d) cooling the composition from step c);

In an embodiment the present invention provides a process for preparing a texturized plant-based food product, the process comprising the steps of:
a) Heating a composition comprising sugar and cysteine or glutathione or a combination thereof with at least one further amino acid or vitamin selected from arginine, glutamic acid, alanine, glycine, lysine, threonine, thiamine or a combination thereof to a temperature between 40 to 100° C. for 2 to 60 min to obtain a pre-reacted flavor precursor;
b) feeding a chamber with a composition comprising 10-70 wt % water, 15-80 wt % plant protein and the pre-reacted flavor precursor from step a);
c) conveying the composition from step b) through the chamber and applying shear, wherein the composition reaches a temperature between 80 to 200° C. under a pressure between 3 to 40 bar to texturize the plant protein;
d) cooling the composition from step c);
e) cutting the cooled texturized composition from step d).

In an embodiment the present invention provides a process for preparing a texturized plant-based food product, the process comprising the steps of:
a) Heating a composition comprising sugar and cysteine or glutathione or a combination thereof with at least one further amino acid or vitamin selected from arginine, glutamic acid, alanine, glycine, lysine, threonine, thiamine or a combination thereof to a temperature between 40 to 100° C. for 2 to 60 min to obtain a pre-reacted flavor precursor;
b) feeding a chamber with a composition comprising 10-70 wt % water, 15-80 wt % plant protein and the pre-reacted flavor precursor from step a);
c) conveying the composition from step c) through the chamber and applying shear, wherein the composition reaches a temperature between 80 to 200° C. under a pressure between 3 to 40 bar to texturize the plant protein;
d) cooling the composition from step c);
   wherein the process is an extrusion process and wherein the chamber is an extruder barrel.

In an embodiment the present invention provides a process for preparing a texturized plant-based food product, the process comprising the steps of:
a) Heating a composition comprising sugar and cysteine or glutathione or a combination thereof with at least one further amino acid or vitamin selected from arginine, glutamic acid, alanine, glycine, lysine, threonine, thiamine or a combination thereof to a temperature between 40 to 100° C. for 2 to 60 min to obtain a pre-reacted flavor precursor;
b) feeding a chamber with a composition comprising 10-70 wt % water, 15-80 wt % plant protein and the pre-reacted flavor precursor from step a);
c) conveying the composition from step b) through the chamber and applying shear, wherein the composition reaches a temperature between 80 to 200° C. under a pressure between 3 to 40 bar to texturize the plant protein;
d) cooling the composition from step c);
e) cutting the cooled texturized composition from step d);
   wherein the process is an extrusion process and wherein the chamber is an extruder barrel.

In an embodiment the present invention provides a process for preparing a texturized plant-based food product, the process comprising the steps of:
a) Heating a composition comprising sugar and cysteine or glutathione or a combination thereof with at least one further amino acid or vitamin selected from arginine, glutamic acid, alanine, glycine, lysine, threonine, thiamine or a combination thereof to a temperature between 40 to 100° C. for 2 to 60 min to obtain a pre-reacted flavor precursor;
b) feeding a chamber with a composition comprising 45-70 wt % water, 15-35 wt % plant protein and the pre-reacted flavor precursor from step a);
c) conveying the composition from step b) through the chamber and applying shear, wherein the composition reaches a temperature between 80 to 200° C. under a pressure between 3 to 40 bar to texturize the plant protein;
d) cooling the composition from step c);
e) cutting the cooled texturized composition from step d);
   wherein the process is an extrusion process and wherein the chamber is an extruder barrel.

In an embodiment the present invention provides a process for preparing an extruded plant-based food product, the process comprising the steps of:
a) Heating a composition comprising sugar and cysteine or glutathione or a combination thereof with at least one further amino acid or vitamin selected from arginine, glutamic acid, alanine, glycine, lysine, threonine, thiamine or a combination thereof to a temperature between 40 to 100° C. for 2 to 60 min to obtain a pre-reacted flavor precursor;
b) feeding an extruder barrel with a composition comprising 45-70 wt % water, 15-35 wt % plant protein and the pre-reacted flavor precursor from step a);
c) extruding the composition from step b) in extruder barrels above the texturization temperature of the plant protein at a temperature between 80 to 200° C.;
d) cooling the composition from step c) through a cooling die;
e) cutting the cooled extruded composition from step d).

In an embodiment the present invention provides a process for preparing an extruded plant-based food product, the process comprising the steps of:
a) Heating a composition comprising sugar and cysteine or glutathione or a combination thereof with at least one further amino acid or vitamin selected from arginine, glutamic acid, alanine, glycine, lysine, threonine, thiamine or a combination thereof to a temperature between 40 to 100° C. for 2 to 60 min to obtain a pre-reacted flavor precursor;
b) feeding an extruder barrel with a composition comprising 10-35 wt % water, 25-80 wt % plant protein and the pre-reacted flavor precursor from step a);
c) extruding the composition from step b) in extruder barrels above the texturization temperature of the plant protein at a temperature between 80 to 200° C.;
d) cooling the composition from step c);
e) drying the extruded composition from step d).

It has been surprisingly found by the inventors that by using the above-mentioned process a texturized plant-based food product having a fibrous appearance and less plant protein off-taste can be obtained. The process of the present disclosure allows the continuous production of a texturized plant-based food product that has a fibrous appearance of real meat with less plant protein off-taste and having a meaty and/or savoury flavor note. It has now been found by the inventors that by in-situ flavor generation with 0.1-5 wt % sugar and 0.05-1 wt % cysteine or glutathione or a combination thereof in the texturized process surprisingly has a beneficial effect plant proteins. In regarding reducing t addition, a savoury and/or meaty flavor is created.

All percentages expressed herein are by weight of the total weight of the texturized plant-based food product unless expressed otherwise.

The terms “food,” “food product” and “food composition” mean a product or composition that is intended for ingestion by an animal, including and preferably a human, and provides at least one nutrient to the animal or human, preferably a human. In an embodiment the terms “food,” “food product” and “food composition” mean a product or composition that is intended for ingestion by a human.

A “plant-based food product” is a composition in which meat (i.e. skeletal tissue and non-skeletal muscle from mammals, fish and fowl) and meat by-products (i.e. the non-rendered clean parts, other than meat, derived from slaughtered mammals, fowl or fish) are completely absent.

The term “texturized” mean that the plant-based food product has layers of aligned fibers similar to the texture of meat.

“Extrusion” is a process used to create objects of a fixed cross-sectional profile. A material is pushed or pulled through a die of the desired cross-section. The two main advantages of this process over other manufacturing processes are its ability to create very complex cross-sections, and to prepare products that are brittle or visco-elastic or elastic, because the material only encounters compressive and shear stresses. Extruders typically comprise an extruder barrel within which rotates a at least one close-fitting screw. The screw is made up of screw elements, some of which are helical screw threads to move material through the extruder barrel. Material is introduced into the extruder barrel toward one end, moved along the extruder barrel by the action of the screw and is forced out of the extruder barrel through a nozzle or die at the other end. The rotating screw mixes and works the material in the barrel and compresses it to force it through the die or nozzle. The degree of mixing and work to which the material is subjected, the speed of movement of the material through the extruder barrel and thus the residence time in the extruder barrel and the pressure developed in the extruder barrel can be controlled by the pitch of the screw thread elements, the speed of rotation of the screw and the rate of introduction of material into the extruder barrel. The extruder barrel comprises multiple extruder barrel sections which are joined end to end. Multiple extruder barrel sections are required to carry out different processes involved in extrusion such as conveying, kneading, mixing, devolatilizing, metering and the like. Each extruder barrel section comprises a liner which is press fit into an extruder barrel casing, and heating and cooling elements are provided to regulate temperature of extruder barrel section within permissible range. The total length of an extrusion process can be defined by its modular extrusion barrel length. An extruder barrel is described by its unit of diameter.

The term “plant protein” includes “plant protein isolates” or “plant protein concentrates” or “plant protein flours” or combination thereof, preferably plant protein concentrates. The person skilled in the art knows how to calculate the amount of plant protein within a plant protein concentrate or plant protein isolate or plant protein flours. The term “plant protein concentrate” as used herein is a plant material having a protein content between 50-90% (plant protein on a moisture-free basis), preferably between 65-75% (plant protein on a moisture-free basis). Plant protein concentrate also contains plant fiber, typically from about 3.5% up to about 20% by weight on a moisture-free basis. The term plant protein isolate, as used herein is a plant material having a protein content of at least about 90% plant protein on a moisture free basis, preferably between 90-96% (plant protein on a moisture-free basis). In a preferred embodiment the texturized plant-based food product does not comprise protein from an animal source.

Plant protein include plant protein concentrate or plant protein isolate or plant protein flours from pea protein, chickpea protein, corn protein (e.g., ground corn or corn gluten), wheat protein (e.g., ground wheat or wheat gluten such as vital wheat gluten), potato protein, legume protein such as soy protein (e.g., soybean meal, soy concentrate, or soy isolate), rice protein (e.g., ground rice or rice gluten), barley protein, algae protein, hemp protein, oat protein, canola protein, fava protein or combinations thereof. Preferably the plant protein is wheat gluten, pea protein, chickpea protein, canola protein, hemp protein, fava protein, soy protein or a combination thereof, more preferably pea protein, soy protein, wheat gluten or a combination thereof.

Plant protein concentrate is a plant material having a protein content between 70 to 85% on a moisture free basis, preferably 80%. Plant protein isolate is a plant material having a protein content above 90% on a moisture free basis. Plant protein flour is a plant material having a protein content between 40 to 60% on a moisture e free basis, preferably 50%. In a further embodiment, the process for preparing a texturized plant-based food product of the invention comprises plant protein within step a) in the amount of 15-80 wt % (based on the composition), preferably 15-75 wt %, preferably 15-70 wt %, preferably 15-65 wt %, preferably 20-80 wt %, preferably 20-75 wt %, preferably 20-70 wt %, preferably 20-65 wt %, preferably 20-60 wt %, preferably 20-55 wt %, preferably 20-50 wt %, preferably 25-80 wt %, preferably 25-70 wt %, preferably 25-65 wt %, preferably 25-60 wt %, preferably 25-55 wt %, preferably 25-50 wt %, preferably 30-80 wt %, preferably 30-75 wt %, preferably 30-70 wt %, preferably 30-65 wt %, preferably 30-60 wt %, preferably 30-55 wt %, preferably 40-80 wt %, 40-75 wt %, preferably 40-70 wt %, preferably 40-65 wt %, preferably 40-60 wt %, preferably 40-55 wt %, preferably 50-80 wt %, preferably 50-70 wt %, preferably 20-40 wt %, preferably 25-40 wt %, preferably 15-40 wt %, preferably 15-35 wt %, preferably 15-30 wt %, 15-25 wt %, preferably 20-35 wt %, preferably 25-35 wt %, preferably 20-40 wt %, preferably 20-30 wt % (based on the composition). In a further embodiment, the process for preparing a texturized plant-based food product of the invention comprises soy protein, pea protein, wheat gluten or a combination thereof within step a) in the amount of 15-80 wt % (based on the composition), preferably 15-75 wt %, preferably 15-70 wt %, preferably 15-65 wt %, preferably 20-80 wt %, preferably 20-75 wt %, preferably 20-70 wt %, preferably 20-65 wt %, preferably 20-60 wt %, preferably 20-55 wt %, preferably 20-50 wt %, preferably 25-80 wt %, preferably 25-70 wt %, preferably 25-65 wt %, preferably 25-60 wt %, preferably 25-55 wt %, preferably 25-50 wt %, preferably 30-80 wt %, preferably 30-75 wt %, preferably 30-70 wt %, preferably 30-65 wt %, preferably 30-60 wt %, preferably 30-55 wt %, preferably 40-80 wt %, preferably 40-75 wt %, preferably 40-70 wt %, preferably 40-65 wt %, preferably 40-60 wt %, preferably 40-55 wt %, preferably 50-80 wt %, preferably 50-70 wt %, preferably 20-40 wt %, preferably 25-40 wt %, preferably 15-40 wt %, preferably 15-35 wt %, preferably 15-30 wt %, preferably 15-25 wt %, preferably 20-35 wt %, preferably 25-35 wt %, preferably 20-40 wt %, preferably 20-30 wt % (based on the composition). In a further embodiment, the process for preparing a texturized plant-based food product of the invention comprises a combination of soy or pea protein with wheat gluten within step a) in the amount of 15-80 wt % (based on the composition), preferably 15-75 wt %, preferably 15-70 wt %, preferably 15-65 wt %, preferably 20-80 wt %, preferably 20-75 wt %, preferably 20-70 wt %, preferably 20-65 wt %, preferably 20-60 wt %, preferably 20-55 wt %, preferably 20-50 wt %, preferably 25-80 wt %, preferably 25-70 wt %, preferably 25-65 wt %, preferably 25-60 wt %, preferably 25-55 wt %, preferably 25-50 wt %, preferably 30-80 wt %, preferably 30-75 wt %, preferably 30-70 wt %, preferably 30-65 wt %, preferably 30-60 wt %, preferably 30-55 wt %, preferably 40-80 wt %, preferably 40-75 wt %, preferably 40-70 wt %, preferably 40-65 wt %, preferably 40-60 wt %, preferably 40-55 wt %, preferably 50-80 wt %, preferably 50-70 wt %, preferably 20-40 wt %, preferably 25-40 wt %, preferably 15-40 wt %, preferably 15-35 wt %, preferably 15-30 wt %, preferably 15-25 wt %, preferably 20-35 wt %, preferably 25-35 wt %, preferably 20-40 wt %, preferably 20-30 wt % (based on the composition). In a further embodiment, the process for preparing a texturized plant-based food product of the invention comprises soy protein and wheat gluten within step a) in the amount of 15-80 wt % (based on the composition), preferably 15-75 wt %, preferably 15-70 wt %, preferably 15-65 wt %, preferably 20-80 wt %, preferably 20-75 wt %, preferably 20-70 wt %, preferably 20-65 wt %, preferably 20-60 wt %, preferably 20-55 wt %, preferably 20-50 wt %, preferably 25-70 wt %, preferably 25-65 wt %, preferably 25-60 wt %, preferably 25-55 wt %, preferably 25-50 wt %, preferably 30-80 wt %, preferably 30-75 wt %, preferably 30-70 wt %, preferably 30-65 wt %, preferably 30-60 wt %, preferably 30-55 wt %, preferably 40-80 wt %, preferably 40-75 wt %, preferably 40-70 wt %, preferably 40-65 wt %, preferably 40-60 wt %, preferably 40-55 wt %, preferably 50-80 wt %, preferably 50-70 wt %, preferably 20-40 wt %, preferably 25-40 wt %, preferably 15-40 wt %, preferably 15-35 wt %, preferably 15-30 wt %, preferably 15-25 wt %, preferably 20-35 wt %, preferably 25-35 wt %, preferably 20-40 wt %, preferably 20-30 wt % (based on the composition). In a further embodiment the plant protein is selected from a combination of at least two different plant proteins, wherein said plant proteins comprise wheat gluten and at least one other plant protein selected from pea protein, chickpea protein, soy protein, faba bean protein, and canola protein and wherein wheat gluten comprises between 20 to 70% of total plant protein in the plant protein mixture, preferably between 40-60%. A combination of wheat gluten and at least one other plant protein has the advantage of a softer texture resulting in an even more tender product.

In a further embodiment, the process for preparing a texturized plant-based food product of the invention comprises water within step a) in an amount of 10-70 wt % (based on the composition), preferably 15-70 wt %, preferably 20-70 wt %, preferably 15-45 wt %, preferably 15-40 wt %, preferably 10-35 wt %, preferably 10-30 wt %, preferably 10-25 wt %, preferably 10-20 wt %, preferably 15-30 wt %, preferably 15-25 wt %, preferably 40-70 wt %, preferably 45-70 wt %, preferably 45-65 wt %, preferably 50-70 wt %, preferably 50-65 wt %, preferably 55-70 wt %, preferably 55-65 wt % (based on the composition). The invention is related to a low moisture extrusion process as well as to a high moisture extrusion process. In a low moisture extrusion process, the water content may range from 10% to about 35% by weight. Alternatively, in a high moisture extrusion process, the water content may range from about 45% to about 70% by weight.

In a further embodiment, the process for preparing a texturized plant-based food product of the invention comprises sugar in an amount of 0.1-5 wt % (based on the composition), preferably 0.2-5 wt %, preferably 0.3-5 wt %, preferably 0.1-4 wt %, preferably 0.2-4 wt %, preferably 0.3-4 wt % (based on the composition).

In an embodiment the term sugar includes from disaccharides, ketoses or aldose or a combination thereof. In an embodiment the term sugar includes erythrose, xylose, ribose, rhamnose, arabinose, lyxose, glucose, galactose, mannose, maltose, isomaltose, lactose, fructose, sorbose, psicose, ribulose or a combination thereof, preferably xylose, ribose, rhamnose, arabinose, glucose, galactose, maltose, lactose, fructose or a combination thereof.

In a further embodiment, the process for preparing a texturized plant-based food product of the invention comprises cysteine or glutathione or a combination thereof in an amount of 0.05-1 wt % (based on the composition), preferably 0.05-0.9 wt %, preferably 0.05-0-8 wt %, preferably 0.05-0.7 wt %, preferably 0.1-1 wt %, preferably 0.1-0.9 wt %, preferably 0.1-0.8 wt %, preferably 0.1-0.7 wt % (based on the composition).

In a further embodiment, the process for preparing a texturized plant-based food product of the invention further comprises at least one amino acid or vitamin selected from 0.05-1 wt % arginine, 0.05-5 wt % glutamic acid, 0.05-2 wt % alanine, 0.05-2 wt % glycine, 0.02-2 wt % lysine, 0.05-2 wt % threonine, 0.01-0.5 wt % thiamine or a combination thereof.

In a further embodiment, the process for preparing a texturized plant-based food product of the invention further comprises 0.01-0.5 wt % thiamine and at least one further amino acid selected from 0.05-1 wt % arginine, 0.05-5 wt % glutamic acid, 0.05-2 wt % alanine, 0.05-2 wt % glycine, 0.02-2 wt % lysine, 0.05-2 wt % threonine or a combination thereof.

In a further embodiment, the process for preparing a texturized plant-based food product of the invention further comprises thiamine in an amount of 0.01-0.5 wt % (based on the composition), preferably 0.01-0.4 wt %, preferably 0.01-0.3 wt %, preferably 0.05-0.5 wt %, preferably 0.05-0.4 wt %, preferably 0.05-0.3 wt %, preferably 0.05-0.2 wt % (based on the composition).

In a further embodiment, the process for preparing a texturized plant-based food product of the invention further comprises alanine in an amount of 0.05-2 wt % (based on the composition), preferably 0.05-1.5 wt %, preferably 0.05-1 wt %, preferably 0.1-2 wt %, preferably 0.1-1.5 wt %, preferably 0.1-1 wt %, preferably 0.1-0.8 wt % (based on the composition).

In a further embodiment, the process for preparing a texturized plant-based food product of the invention further comprises glycine in an amount of 0.05-2 wt % (based on the composition), preferably 0.05-1.5 wt %, preferably 0.05-1 wt %, preferably 0.1-2 wt %, preferably 0.1-1.5 wt %, preferably 0.1-1 wt %, preferably 0.1-0.8 wt % (based on the composition).

In a further embodiment, the process for preparing a texturized plant-based food product of the invention further comprises arginine in an amount of 0.05-1 wt % (based on the composition), preferably 0.05-0.8 wt %, preferably 0.05-0.5 wt %, preferably 0.1-1 wt %, preferably 0.1-0.8 wt %, preferably 0.1-0.5 wt % (based on the composition).

In a further embodiment, the process for preparing a texturized plant-based food product of the invention further comprises lysine in an amount of 0.05-2 wt % (based on the composition), preferably 0.05-1.5 wt %, preferably 0.05-1 wt %, preferably 0.1-2 wt %, preferably 0.1-1.5 wt %, preferably 0.1-1 wt %, preferably 0.1-0.8 wt % (based on the composition).

In a further embodiment, the process for preparing a texturized plant-based food product of the invention further comprises threonine in an amount of 0.05-2 wt % (based on the composition), preferably 0.05-1.5 wt %, preferably 0.05-1 wt %, preferably 0.1-2 wt %, preferably 0.1-1.5 wt %, preferably 0.1-1 wt %, preferably 0.1-0.8 wt % (based on the composition).

In a further embodiment, the process for preparing a texturized plant-based food product of the invention further comprises a lipid in an amount of 1-10 wt % (based on the composition), preferably 1.5-10 wt %, preferably 2-10 wt %, preferably 2-8 wt %, preferably 2-7 wt %, preferably 2-6 wt %, preferably 3-8 wt %, preferably 3-7 wt % (based on the composition). In an embodiment of the invention the lipid is added into a chamber (extruder barrel) at a location down-stream of the feeding location of step a). The process of lipid-injection is described in WO2016150834. The term lipid includes any liquid oil, fat or combination thereof. In an embodiment the term lipid includes soybean oil, corn oil, sunflower oil, high oleic sunflower oil, olive oil, canola oil, safflower oil, peanut oil, palm oil, cottonseed oil, coconut oil, almond oil, hazelnut oil, rape seed oil, fractionated palm fat, fully or partially hydrogenated or inter-esterified palm oil and combinations thereof. Preferably the lipid is sunflower oil.

The term “flavouring” in the context of this invention includes salt, flavouring agents, acids, taste enhancing ingredients, herbs, spices, vegetables or mixtures thereof, which are suitable for being used in a food product. Taste enhancing ingredients may be provided by monosodium glutamate (MSG) and/or yeast extract etc. Salt refers to any suitable alkali metal salt or mixture thereof. The salt used in the composition of this invention is typically, but not limited to, sodium chloride. For example, potassium chloride may be used or any low-sodium product having a taste impression of sodium chloride may be used, as long as the taste in the end formulation is acceptable. Acids may be provided by vinegar, lactic acid, citric acid or combination thereof. In a further embodiment, the texturized plant-based food product of the invention further comprises flavouring in the amount of 0.5-40 wt % (based on the composition), preferably 0.5-35 wt %, preferably 0.5-30 wt %, preferably 0.5-25 wt %, preferably 0.5-20 wt %, preferably 0.5-15 wt %, preferably 0.5-10 wt %, preferably 2-10 wt %, preferably 2-8 wt %, preferably 3-8 wt % (based on the composition).

In an embodiment of the invention, the texturized plant-based food product comprises one or more fortification compounds as vitamins, minerals and iron salts. The term vitamins include Vitamins A, B-complex (such as B-1, B-2, B-6 and B-12), C, D, E and K, niacin, and acid vitamins such as pantothenic acid, folic acid and biotin, preferably vitamin B-12. The term minerals include calcium, iron, magnesium, zinc, iodine, copper, phosphorus, manganese, potassium, chromium, molybdenum, selenium, nickel, tin, silicon or vanadium. The term iron salts include ferric sodium EDTA, reduced iron, ferrous lactate, ferric citrate, ferric pyrophosphate, ferrous sulphate monohydrate or ferric ammonium citrate brown, preferably ferric pyrophosphate. Specific amounts of fortification compounds will depend on a variety of factors such as the identity of the ingredient; the species of animal; the animal's age, body weight, general health, sex, and diet; the animal's consumption rate; the purpose for which the food product is administered to the animal; and the like. Therefore, the components and their amounts may vary widely. Fortification compounds can be added into the texturization process.

In an embodiment the texturized plant-based food product can also comprise one or more colorants. The term colorant include FD&C colors, such as blue no. 1, blue no. 2, green no. 3, red no. 3, red no. 40, yellow no. 5, yellow no. 6, and the like; natural colorants and/or coloring food stuff, such as caramel coloring, annatto, chlorophyllin, cochineal, betanin, turmeric, saffron, paprika, lycopene, elderberry juice, pandan, butterfly pea and the like; titanium dioxide; carbon carbonate; and any suitable food colorant known to the skilled artisan. In one other embodiment of the present invention, the colorant is selected from bell pepper, beetroot, carrot, black current, malted barley powder or combination thereof. In one embodiment of the present invention the meat analogue product comprises between 0.1-10 wt % (weight percent of the total composition) of colorants, preferably between 0.1-5 wt % (weight percent of the total composition).

In a further embodiment water might be mixed to a dry plant protein before feeding the chamber or extruder barrels through a slurry inlet. In case the plant protein is mixed with water before feeding the chamber or extruder barrel, the non-meat dough can be transferred, for example by pumping, from the mixing device. In an embodiment, the non-meat dough is transferred directly from the mixing device to the chamber or extruder barrel without any other processing or addition or removal of ingredients.

In a further embodiment plant protein in the form of a dry powder is added to the chamber or extruder barrel and water is added separately to the chamber or extruder barrel. The mixing of the dry plant protein and water is done within the chamber or extruder barrel through the mechanical energy force. Therefore, it is not necessary to form a dough of the plant protein and water before feeding the chamber or extruder barrel.

The chamber or extruder barrels are heated to a temperature of between 80-200° C., preferably 90-190° C. The pressure is between 3-40 bar, preferably 10-30 bar, preferably 10-20 bar. In case of extrusion the screw speed is around 50-600 rpm, preferably 50-500 rpm, preferably 100-600 rpm, preferably 200-600 rpm, preferably between 200-500 rpm, preferably between 200-400 rpm.

The term “cooling” means that the temperature of the extrudate is decreased to a desired temperature. Cooling is preferably done through a cooling die, preferably for a high moisture extrusion process. A “cooling die” is cooling the extruded product to a desired temperature. During the cooling within the cooling die both the temperature and the pressure are gradually reduced as the heated non-meat dough travels through the cooling device. The dough has moisture and is under elevated temperature, so preferably moisture flashing is controlled to avoid rapid expansion of the food product. Product expansion that is too rapid can disrupt the structure of the texturized food product. However, depending on the desired image of the final food product, some flashing may be required to reduce the temperature of the centre of the food product and/or to expose some of the fibers in the food product. In a preferred embodiment of the invention flashing is avoided. In an embodiment, the texturized mixture undergoes a decrease in pressure at a predetermine rate in the cooling device and/or is subjected to a predetermined final pressure at the end of the cooling device. In an embodiment, the extruded mixture, preferably a high moisture extrudate, has an exit temperature at the end of the cooling die between 40-110° C., preferably between 50-100° C., preferably between 50-98° C., preferably between 60-95° C., preferably between 60-90° C., preferably between 65-98° C., preferably between 65-95° C., preferably between 65-90° C., preferably between 70-90° C. In an embodiment, the extruded mixture, preferably a low moisture extrudate, has an exit temperature between 120-180° C., preferably between 130-170° C., preferably between 140-165° C. The extrudate is preferably cooled by ambient temperature of the atmosphere.

The term “cutting” means that the texturized plant-based food product can be sliced, cut, ground, shredded, grated or a combination thereof, preferably sliced or cut. Cutting can be done with static, rotating or vibrating knives having vertical, horizontal and/or diagonal knives, depending on the shape of the food product to be manufactured.

Those skilled in the art will understand that they can freely combine all features of the present invention disclosed herein. In particular, features described for the composition of the present invention may be combined with the process for the preparation of the composition, and vice versa. Further, features described for different embodiments of the present invention may be combined. Further advantages and features of the present invention are apparent from the examples. It will be appreciated that the invention as claimed is not intended to be limited in any way by these examples.

### EXAMPLES

### Sensory Evaluation of Texturized Plant Proteins:

The different texturized plant proteins examples were cooked in a frying pan for 5 min to reach a 160 F and served while hot to the skilled technical assessors for evaluation.
Comparative technical sensory analysis was selected as a quick method to provide an assessment of the different sensory attributes of the texturized plant protein prototypes (produced with pre-reacted flavor precursors) vs the reference texturized proteins (without any pre-reacted flavor precursors).
The sensory attributes were selected as the most relevant characteristics to describe the samples.
Eight skilled technical assessors were asked to score the difference in sensory intensities of test sample vs. the reference (REF).
This was done using a bipolar 7-point structured scale going from −3 to +3, 0 being similarity with the reference.
Water at room temperature and unsalted crackers were used by technical assessors to clean their palates between samples

### Cooking the Meat Analogue Burgers

Prepare 113 g plant-based burger patties, with 9 cm diameter and 2 cm thickness. Heat up a frying pan at medium-high heat until it smokes slightly, about 2 minutes.
Place the plant-based burger patty in the frying pan and let cook until brown
Flip the burger and let cook until brown
Check & ensure temperature inside at 1650 F
Serve while hot to the technical assessors

### Technical Assessment of the Plant-Based Burgers

Both cooked burgers; reference burger made with pure texturized plant proteins and burger with savory texturized plant proteins were evaluated and compared by skilled technical assessors:
Comparative technical sensory analysis was selected as a quick method to provide an assessment of the different sensory attributes.
The sensory attributes were selected as the most relevant characteristics to describe the meat analogue burger samples
Eight to ten skilled technical assessors were asked to score the difference in sensory intensities of test sample vs. the reference (REF).
This was done using a bipolar 7-point structured scale going from −3 to +3, 0 being similarity with the reference.
Water at room temperature and unsalted crackers were used by technical assessors to clean their palates between samples

### Examples 1: Process

The examples are describing the preparation of a texturized plant-based food product by the process of this invention. A dry mix of the plant protein, sugar and cysteine or glutathione was added through a hopper into the extruder barrel and water is separately injected into the extruder. The extruder barrels are heated within a curve between 80-180° C. In case of a high moisture extrusion process the cooling die is cooling the extruded mixture to an exit temperature of 90° C. In case of a low moisture extrusion process the extrudate is cooled by the ambient temperature of the atmosphere. The texturized product is cut. The product was made on a Bühler B93 twin screw extruder from the following materials:

### Examples 2 to 14

Examples 2 to 14 have been prepared according to the process described in example 1 with the difference that comparison example 2 does not use any sugar and cysteine or glutathione.

| | Comp. | Comp. | Comp. | Comp. | |
|---|---|---|---|---|---|
| Ingredients | Ex. 2 | Ex. 3 | Ex. 4 | Ex. 5 | Ex. 6 |
| Soy protein | 47 | 47 | 47 | 47 | 47 |
| concentrate (wt %) | | | | | |
| Water (wt %) | 53 | 52.9 | 52.5 | 52.8 | 51.45 |
| Sugar (ribose/xylose) | — | — | 0.5 | — | 0.35 |
| Cysteine | — | — | — | 0.2 | 0.2 |
| Thiamine | — | 0.1 | — | — | — |
| Yeast extract (27- | — | — | — | — | — |
| 30 wt % cysteine) | | | | | |
| Yeast extract (27- | — | — | — | — | — |
| 30 wt % glutathione) | | | | | |

Sensory results

| | | | | | |
|---|---|---|---|---|---|
| Plant off-note | +++ | +++ | +++ | +++ | ++ |
| Savoury tonality | None | None | None | None | + |

| Ingredients | Ex. 7 | Ex. 8 | Ex. 9 | Ex. 10 | Ex. 11 |
|---|---|---|---|---|---|
| Soy protein | 35 | 35 | 47 | 47 | 47 |
| concentrate (wt %) | | | | | |
| Water (wt %) | 62.5 | 62.5 | 52.45 | 50 | 49.85 |
| Sugar (ribose/xylose) | 0.5 | 0.5 | 0.25 | 0.5 | 0.5 |
| Cysteine | — | — | 0.2 | 0.2 | 0.2 |
| Thiamine | — | — | 0.1 | 0.1 | — |
| Yeast extract (27- | 2 | — | — | — | — |
| 30 wt % cysteine) | | | | | |
| Yeast extract (27- | — | 2 | — | — | — |
| 30 wt % glutathione) | | | | | |
| Arginine | — | — | — | 0.2 | 0.2 |
| Glutamic acid | — | — | — | 2 | 2 |
| Alanine | — | — | — | — | 0.1 |
| Lysine | — | — | — | — | 0.05 |
| Aspartic acid | — | — | — | — | 0.1 |

Sensory results

| | | | | | |
|---|---|---|---|---|---|
| Plant off-note | ++ | ++ | ++ | + | + |
| Savoury tonality | + | + | + + | +++ | +++ |

| Ingredients | Ex. 12 | Ex. 13 | Ex. 14 |
|---|---|---|---|
| Soy protein | 35 | 47 | 47 |
| concentrate (wt %) | | | |
| Water (wt %) | 63.4 | 51 | 50.5 |
| Sugar (ribose/xylose) | 1 | 0.5 | — |
| Sugar maltextract | — | — | 1 |
| Cysteine | 0.1 | 0.2 | 0.2 |
| Thiamine | — | 0.1 | 0.1 |
| Threonine | 0.1 | — | — |
| Arginine | 0.1 | 0.2 | 0.2 |
| Glutamic acid | — | 1 | 1 |
| Alanine | 0.1 | — | — |
| Lysine | 0.1 | — | — |
| Glycin | 0.1 | — | — |
| Aspartic acid | — | — | — |
| Plant off-note | + | + | + |
| Savoury tonality | + | +++ | +++ |

The addition of thiamin, reducing sugars and cysteine alone did not reduce any plant protein off notes. A mixture with sugar and cysteine or glutathione led to a perceivable reduction in the off aromas and generation of savory tonality. The addition of thiamine or other amino acids improved further the reduction of off aromas and increase of the savory taste.

### Examples 15 to 17

Examples 15 to 17 have been prepared according to the process described in example 1 with the difference that comparison example 15 does not use any flavor precursors. Example 17 use a pre-reacted flavor precursor which is added through a hopper into the extruder barrel.

| | Comp. | | |
|---|---|---|---|
| Ingredients | Ex. 15 | Ex. 16 | Ex. 17 |
| Soy protein concentrate (wt %) | 47 | 47 | 47 |
| Water (wt %) | 53 | 43 | 43 |
| Unreacted flavor precursors (water | — | 10 | — |
| 9%, 0.1% thiamin, 0.5% ribose, 1% | | | |
| glutamic acid, 0.2% cysteine and | | | |
| 0.2% arginine) | | | |
| Pre-reacted flavor precursors at 70 C. | — | — | 10 |
| 15 min (water 98, 0.1% thiamin, 0.5% | | | |
| ribose, 1% glutamic acid, 0.2% | | | |
| cysteine and 0.2% arginine) | | | |

Sensory results

| | | | |
|---|---|---|---|
| Plant off-note | +++ | + | + |
| Savoury tonality | None | +++ | +++ |

(+) Slightly perceived
(++) Moderately perceived
(+++) Strongly perceived

Both savoury texturized plant proteins with unreacted precursors and pre-reacted flavor precursors showed a clear reduction in plant protein off notes and a positive and desirable savoury tones.

### Examples 18 to 19

Examples 18 to 19 illustrates the formulas that were used to form the following burgers. Example 18 is a plant-based burger with pure texturized plant proteins without any addition of flavor precursors during protein texturization. Example 19 is a plant-based burger with savory textured proteins where flavor precursors reacted during protein texturization.

| | Comp. | |
|---|---|---|
| Ingredients | Ex. 18 | Ex. 19 |
| Pure textured plant proteins: | 52.43 | — |
| texturization of plant proteins with | | |
| only water as in comp. ex. 2 | | |
| Savory textured plant proteins: | — | 52.43 |
| texturization of plant proteins, | | |
| water, sugar and flavor precursors | | |
| as in example 13 | | |
| Water (wt %) | 16.05 | 16.05 |
| Coconut oil | 4 | 4 |
| Vinegar | 1 | 1 |
| Starch | 1 | 1 |
| Colour | 0.52 | 0.52 |
| Gelling solution (binder) | 24 | 24 |
| Flavor | 1 | 1 |

Sensory results

| | | |
|---|---|---|
| Plant off-note | +++ | + |
| Savoury tonality | None | +++ |

There was no visual difference between the reference burger made with pure textured plant protein vs. the burger with savory textured plant proteins: The comparative assessment carried out with the skilled technical assessors showed that the burger with savory texturized plant proteins effectively reduced the soy/beany/cereal aroma notes when compared to the reference burger. It also increased roast/meaty note in addition to the savory and umami taste with a lingering salivating effect when compared to the reference burger.

### Example 20

Example 20 has been prepared according to the process described in example 1 with the difference that a front plate is used instead of a cooling die.

| Ingredients | Ex. 20 |
|---|---|
| Soy protein flour (wt %) | 78 |
| Water (wt %) | 18.5 |
| Sugar (ribose/xylose) | — |
| Sugar maltextract | 1 |
| Cysteine | 0.2 |
| Thiamine | 0.02 |
| Threonine | — |
| Arginine | — |
| Glutamic acid | 0.2 |
| Sodium chloride | 2.08 |

Sensory results

| | |
|---|---|
| Plant off-note | + |
| Savoury tonality | ++ |

1. A process for preparing a texturized plant-based food product, the process comprising the steps of:
a) feeding a chamber with a composition comprising 10-70 wt % water, 15-80 wt % plant protein, 0.1-5 wt % sugar and 0.05-1 wt % cysteine or glutathione or a combination thereof;
b) conveying the composition from step a) through the chamber and applying shear, wherein the composition reaching a temperature between 80 to 200° C. under a pressure between 3 to 40 bar to texturize the plant protein; and
c) cooling the composition from step b).

2. The process for preparing a texturized plant-based food product according to claim 1, wherein the plant-based protein is selected from the group consisting of soy protein, pea protein, chickpea protein, canola protein, hemp protein, oat protein, fava protein, pumpkin protein, sunflower protein or wheat gluten, and a combination thereof.

3. The process for preparing a texturized plant-based food product according to claim 1, wherein the sugar is selected from the group consisting of aldoses, disaccharides, ketoses and a combination thereof.

4. The process for preparing a texturized plant-based food product according to claim 1, wherein the sugar is selected from the group consisting of erythrose, xylose, ribose, rhamnose, arabinose, lyxose, glucose, galactose, mannose, maltose, isomaltose, lactose, fructose, sorbose, psicose, ribulose and a combination thereof.

5. The process for preparing a texturized plant-based food product according to claim 1, wherein the composition in step a) further comprises at least one amino acid or vitamin selected from the group consisting of 0.05-1 wt % arginine, 0.05-5 wt % glutamic acid, 0.05-2 wt % alanine, 0.05-2 wt % glycine, 0.02-2 wt % lysine, 0.05-2 wt % threonine, 0.01-0.5 wt % thiamine and a combination thereof.

6. The process for preparing a texturized plant-based food product according to claim 1, wherein the composition in step a) further comprises at least one amino acid or vitamin selected from the group consisting of 0.05-1 wt % arginine, 0.05-5 wt % glutamic acid, 0.05-2 wt % alanine, 0.05-2 wt % glycine, 0.02-2 wt % lysine, 0.05-2 wt % threonine, 0.01-0.5 wt % thiamine and a combination thereof and wherein the sugar and the amino acids are pre-reacted at a temperature between 40-100° C. before feeding to the chamber in step a).

7. The process for preparing a texturized plant-based food product according to claim 1, wherein the texturized composition is cooled to temperature between 50-110° C.

8. The process for preparing a texturized plant-based food product according to claim 1 further comprises a cutting of the texturized composition after step c).

9. The process for preparing a texturized plant-based food product according to claim 1, wherein the process is an extrusion process and wherein the chamber are extrusion barrels.

10. The process for preparing a texturized plant-based food product according to claim 1, wherein the composition comprises 10 to 35 wt % water and 25 to 80 wt % of plant protein.

11. The process for preparing a texturized plant-based food product according to claim 1, wherein the composition comprises 45 to 70 wt % water and 15 to 35 wt % of plant protein.

12-13. (canceled)
